(19) United States
(12) Patent Application Publication
(10) Pub. No.: US 2026/0004335 A1
(43) Pub. Date: Jan. 1, 2026

(54) SYSTEMS AND METHODS FOR INTERACTIVE LIST BUILDING

(71) Applicant: Walmart Apollo, LLC, Bentonville, AR (US)

(72) Inventors: Sareena Khera, San Diego, CA (US); Qinwei Zu, Seattle, WA (US); Antony Rishin Mukkath Roy, Mountain View, CA (US); Christopher Allen Sundita, Sunnyvale, CA (US)

(21) Appl. No.: 18/757,090

(22) Filed: Jun. 27, 2024

(51) Int. Cl. G06Q 30/0601; G06F 40/30

(52) U.S. Cl. CPC G06Q 30/0633; G06F 40/30

(57) ABSTRACT

This application is directed to systems and methods for building information lists interactively on a cloud-based information platform. In some embodiments, a disclosed method includes obtaining one or more query messages having a natural language format and processing the one or more query messages to generate basic item information and a user request for modifying a target information list with the basic item information. The disclosed method further includes, in response to the user request, generating one or more candidate information items representing a subset of a plurality of information lists available to the first user; while presenting the candidate information items, receiving a user input selecting a target information item representing the target information list; updating the target information list based on the basic item information; and storing the target information list updated based on the basic item information in the memory.

### TECHNICAL FIELD

This application relates generally to information processing and, more particularly, to systems and methods for building information lists based on natural language processing of user queries.

### BACKGROUND

A cloud-based information platform may operate by presenting information items associated with catalog items on user interfaces and prompting user actions with selected information items. The user actions may be identified in response to user-entered queries. The user-entered queries or the user actions necessitate a substantial level of user engagement with the interfaces of the information platform. In many instances, adjustments to user-entered queries and actions must be made and gradually adjusted based on the limited information available via the user interfaces. It is inconvenient and inefficient to rely solely on user-entered queries or actions to interact with the cloud-based information platform's interfaces to determine a user's desired product service and identify matching information items.

### SUMMARY

In various embodiments, a system including a non-transitory memory configured to store instructions thereon and at least one processor is disclosed. The at least one processor is configured to obtain one or more query messages provided by a first user and having a natural language format and process the one or more query messages using a natural language processing model to generate a user request for modifying a target information list with basic item information associated with one or more items and extract. The at least one processor is further configured to, in response to the user request, generate one or more candidate information items representing a subset of a plurality of information lists available to the first user. The at least one processor is further configured to, while presenting the one or more candidate information items to the first user, receive a user input selecting a target information item representing the target information list. The at least one processor is further configured to update the target information list based on the basic item information that is generated by processing the one or more query messages; and store the target information list updated based on the basic item information in the memory.

In various embodiments, a computer-implemented method is disclosed. The computer-implemented method includes steps of obtaining one or more query messages provided by a first user and having a natural language format; processing the one or more query messages using a natural language processing model to generate a user request for modifying a target information list with basic item information associated with one or more items and extract; in response to the user request, generating one or more candidate information items representing a subset of a plurality of information lists available to the first user; while presenting the one or more candidate information items to the first user, receiving a user input selecting a target information item representing the target information list; updating the target information list based on the basic item information that is generated by processing the one or more query messages; and storing the target information list updated based on the basic item information in the memory.

In various embodiments, a non-transitory computer readable medium having instructions stored thereon is disclosed. The instructions, when executed by at least one processor, cause at least one device to perform operations including obtaining one or more query messages provided by a first user and having a natural language format; processing the one or more query messages using a natural language processing model to generate a user request for modifying a target information list with basic item information associated with one or more items and extract; in response to the user request, generating one or more candidate information items representing a subset of a plurality of information lists available to the first user; while presenting the one or more candidate information items to the first user, receiving a user input selecting a target information item representing the target information list; updating the target information list based on the basic item information that is generated by processing the one or more query messages; and storing the target information list updated based on the basic item information in the memory.

### BRIEF DESCRIPTION OF THE DRAWINGS

The features and advantages of the present invention will be more fully disclosed in, or rendered obvious by the following detailed description of the preferred embodiments, which are to be considered together with the accompanying drawings wherein like numbers refer to like parts and further wherein:

FIG. 1 is a network environment configured to provide a user application to a plurality of users, in accordance with some embodiments;

FIG. 2 is a block diagram of a computing device, in accordance with some embodiments;

FIG. 3 illustrates an artificial neural network, in accordance with some embodiments;

FIG. 4 illustrates a tree-based artificial neural network, in accordance with some embodiments;

FIG. 5 illustrates a deep neural network (DNN), in accordance with some embodiments;

FIG. 6 is a flowchart illustrating a training method for generating a trained machine learning model, in accordance with some embodiments;

FIG. 7 is a process flow illustrating various steps of the training method of FIG. 6, in accordance with some embodiments;

FIG. 8 is a flow diagram of a process of updating a target information list in response to one or more query messages of a first user, in accordance with some embodiments;

FIG. 9 is a block diagram of an information processing system, in accordance with some embodiments;

FIG. 10 is a diagram illustrating a set of graphic user interfaces displayed for receiving and processing natural language query messages, in accordance with some embodiments;

FIG. 11 is a flow diagram of a method of rendering a user interface including a predefined information list that is identified as a target information list in response to a query message, in accordance with some embodiments;

FIG. 12 is a diagram illustrating example user interfaces prompting selection of a target information list, in accordance with some embodiments;

FIGS. 13A and 13B are diagrams illustrating two example user interfaces presenting item information added into a target information list, in accordance with some embodiments;

FIG. 14 is a flowchart illustrating a method for managing information, in accordance with some embodiments; and

FIGS. 15A-15H are diagrams showing equations applied to process information, in accordance with some embodiments.

### DETAILED DESCRIPTION

This description of the exemplary embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically and/or wirelessly connected to one another either directly or indirectly through intervening systems, as well as both moveable or rigid attachments or relationships, unless expressly described otherwise. The term “operatively coupled” is such a coupling or connection that allows the pertinent structures to operate as intended by virtue of that relationship. In the following, various embodiments are described with respect to the claimed systems as well as with respect to the claimed methods. Features, advantages or alternative embodiments herein may be assigned to the other claimed objects and vice versa. In other words, claims for the systems may be improved with features described or claimed in the context of the methods. In this case, the functional features of the method are embodied by objective units of the systems.

Various embodiments described herein are directed to systems and methods for determining a user's desired product service and managing associated information items (e.g., data items representative of items included in a catalog) to be distributed to users in response to user queries or requests on a cloud-based information platform. The cloud-based information platform hosts a user application having a plurality of user accounts associated with a plurality of users (e.g., guest users, registered users). The user application includes user interfaces on which information items may be displayed to prompt user actions. The user actions may create further tasks for organizing information associated with different items (e.g., adding information of items into a plurality of distinct information lists). Different information lists are associated with different purposes and different operations to be executed by online and/or offline processes associated with the cloud-based information platform. For example, a predefined information list corresponds to a virtual cart including information of items to be shipped to a user after payment is confirmed by the cloud-based information platform. One or more custom information lists organize information of items in which a user is interested into different categories to facilitate further reviewing or ordering on the cloud-based information platform. Natural language queries allow the users to express a need for adding certain information into lists associated different purposes when the user application displays different functional pages, independently of information content presented for the user application. Examples of the natural language queries include, but are not limited to, “add sea salt to list,” “add candies to my holiday shopping list,” and “add this item to cart.”

In some embodiments, each user account corresponds to a plurality of information lists managed by the cloud-based information platform, and each information list corresponds to a respective type of information of associated items (e.g., specific item information, generic item information, etc.) and respective online or offline operations (e.g., online information storage, offline warehouse order preparation, etc.) implemented by the platform. A target information list and a target item may be identified in natural language queries using a natural language processing model, user inputs, and/or context information (e.g., as extracted from historic transaction data). For example, a user query may include a voice-activated request for adding a particular product item into a weekend shopping list. An information item associated with the target item may be presented as a search result, prompting the user to select the displayed information item and add the target item to the weekend shopping list, which is stored in a database for a corresponding user. Natural language queries may have a higher rate of engagement and higher satisfaction with the service provided by the cloud-based information platform. Additionally, the cloud-based information platform may process user requests more independently without heavily involving user actions, and particularly, may discern different information lists accurately and continue to implement list-based operations efficiently. As such, information is managed for a large number of user accounts by efficient user interactions (e.g., natural language queries, voice inputs, selective user interactions with user interfaces, etc.).

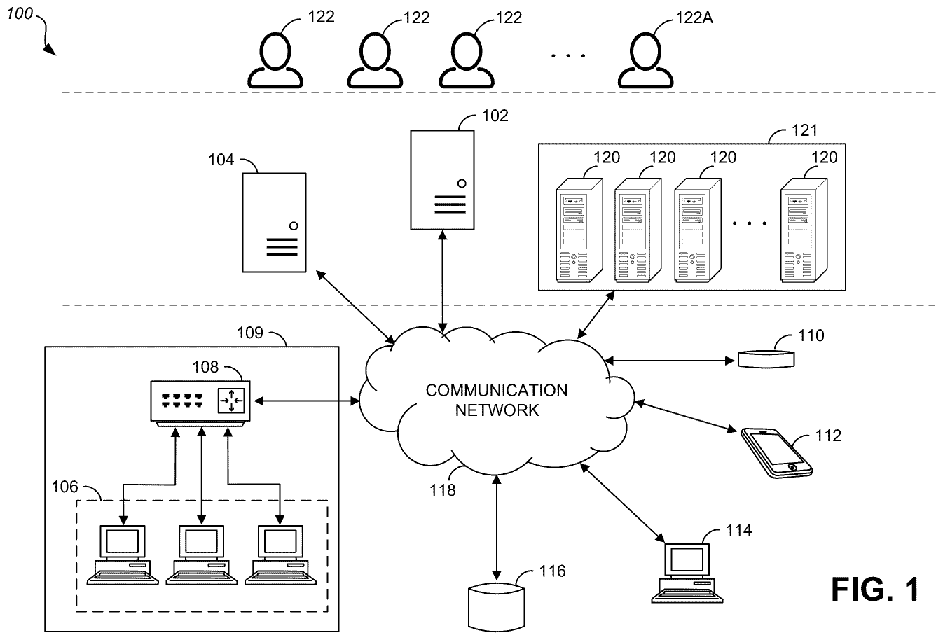

FIG. 1 is a network environment 100 configured to provide a user application (e.g., a network interface application, an online shopping application, etc.) to a plurality of users, in accordance with some embodiments. The network environment 100 includes a plurality of devices or systems configured to communicate over one or more network channels, illustrated as a communication network 118. For example, in various embodiments, the network environment 100 can include, but is not limited to, a computing device 102 (e.g., a server, such as an application server), a web server 104, a cloud-based engine 121 including one or more processing devices 120, workstation(s) 106, a database 116, and one or more user computing devices 110, 112, 114 operatively coupled over the communication network 118. The computing device 102, the web server 104, the workstation(s) 106, the processing devices 120, and the multiple user computing devices 110, 112, 114 may each be any suitable computing device that includes any hardware or hardware and software combination for processing and handling information. For example, each may include one or more processors, one or more field-programmable gate arrays (FPGAs), one or more application-specific integrated circuits (ASICs), one or more state machines, digital circuitry, or any other suitable circuitry. In addition, each may transmit and receive data over the communication network 118.

In some examples, each of the computing device 102 and the processing devices 120 may be a computer, a workstation, a laptop, a server such as a cloud-based server, or any other suitable device. In some examples, each of the processing devices 120 is a server that includes one or more processing units, such as one or more graphical processing units (GPUs), one or more central processing units (CPUs), and/or one or more processing cores. Each processing device 120 may, in some examples, execute one or more virtual machines. In some examples, processing resources (e.g., capabilities) of the one or more processing devices 120 are offered as a cloud-based service (e.g., cloud computing). For example, the cloud-based engine 121 may offer computing and storage resources of the one or more processing devices 120 to the computing device 102.

In some examples, each of the user computing devices 110, 112, 114 may be a cellular phone, a smart phone, a tablet, a personal assistant device, a voice assistant device, a digital assistant, a laptop, a computer, or any other suitable device. In some examples, the web server 104 hosts one or more network environments, or portions thereof, such as an e-commerce environment. In some examples, the computing device 102, the processing devices 120, and/or the web server 104 are operated by a network environment provider, and the multiple user computing devices 110, 112, 114 are operated by users 122 of the network environment. In some examples, the processing devices 120 are operated by a third party (e.g., a cloud-computing provider).

The workstation(s) 106 are operably coupled to the communication network 118 via a router (or switch) 108. The workstation(s) 106 and/or the router 108 may be located at a physical location 109, for example. The workstation(s) 106 may communicate with the computing device 102 over the communication network 118. The workstation(s) 106 may send data to, and receive data from, the computing device 102.

Although FIG. 1 illustrates three user computing devices 110, 112, 114, the network environment 100 may include any number of user computing devices 110, 112, 114. Similarly, the network environment 100 may include any number of the recommendation computing devices 102, the processing devices 120, the workstation(s) 106, the web servers 104, and the databases 116.

The communication network 118 may be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 118 may provide access to, for example, the Internet.

Each of the user computing devices 110, 112, 114 may communicate with the web server 104 over the communication network 118. For example, each of the user computing devices 110, 112, 114 may be operable to view, access, and interact with a website, such as an e-commerce website, hosted by the web server 104. The web server 104 may transmit user session data related to a user's activity (e.g., interactions) on the website. For example, a user may operate one of the user computing devices 110, 112, 114 to initiate a web browser that is directed to the website hosted by the web server 104. The user may, via the web browser, login to or otherwise interact with a software application or web application interface, for example. The website may capture these activities as user session data, and transmit the user session data to the computing device 102 over the communication network 118.

In some examples, the computing device 102 may execute one or more models, such as a natural language processing model 226, etc., to process one or more query messages provided by a first user 122A to generate basic item information associated with the one or more items and extract a user request for modifying a target information list with the basic item information. The computing device 102 may generate one or more candidate information items representing a subset of a plurality of information lists available to the first user 122A, receive a user input selecting a target information item representing the target information list, update the target information list based on the basic item information that is generated by processing the one or more query messages, and store the target information list updated based on the basic item information in the memory. In some embodiments, information of an item is identified in a database 116 (e.g., corresponding to a product catalog) based on the basic item information, and extracted from the database 116. The target information list is updated with the information of the item extracted from the database 116.

The computing device 102 may be further operable to communicate with the database 116 over the communication network 118. For example, the computing device 102 may store data to, and read data from, the database 116. The database 116 may be a remote storage device, such as a cloud-based server, a disk (e.g., a hard disk), a memory device on another application server, a networked computer, or any other suitable remote storage. Although shown remote to the computing device 102, in some examples, the database 116 may be a local storage device, such as a hard drive, a non-volatile memory, or a USB stick. The computing device 102 may store purchase data received from the web server 104 in the database 116. The computing device 102 may also receive from the web server 104 user session data identifying events associated with browsing sessions, and may store the user session data in the database 116.

In some examples, the computing device 102 generates training data for one or more models (e.g., a natural language processing model 226, etc.) based on historical user session data, etc. The computing device 102 may train the models based on their corresponding training data and may store the model(s) in a database, such as in the database 116 (e.g., a cloud storage).

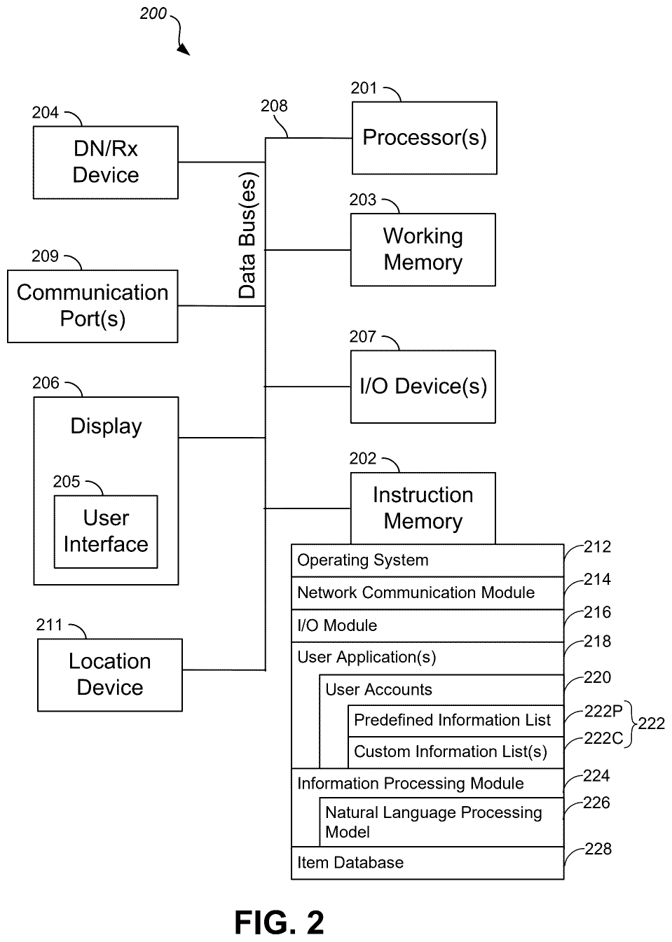

The models, when executed by the computing device 102, allow the computing device 102 to generate a user request from one or more natural language query messages, determine related information (e.g., an information source, a target user) of the user request, and identify one or more information items among the candidate information items for display to the target user. For example, the computing device 102 may obtain the models from the database 116. The computing device 102 may execute the models (e.g., a natural language processing model 226 in FIG. 2) to process one or more query messages received in a natural language format, determine context among the one or more query messages, generate the basic item information, and extract the user request for modifying a target information list based on the basic item information.

In some embodiments, the computing device 102 assigns the models (or parts thereof) for execution to one or more processing devices 120. For example, each model may be assigned to a virtual machine hosted by a processing device 120. The virtual machine may cause the models or parts thereof to execute on one or more processing units such as GPUs. In some examples, the virtual machines assign each model (or part thereof) among a plurality of processing units. Based on the output of the models, computing device 102 may generate ranked item recommendations for items to be displayed on the website to a user.

In some embodiments, the network environment 100 is configured to provide a user application (e.g., a network interface application, an online shopping application, etc.) to a plurality of users 122. An example of the plurality of users 122 is a plurality of users that share resources via the network environment 100. The user application is deployed for the plurality of users 122, and executed to process requests associated with the plurality of users 122 in the network environment 100 after the plurality of users 122 is authenticated and authorized to access the user application. For example, login pages are displayed on the workstation(s) 106 and the multiple user computing devices 110, 112 and 114, allowing the plurality of users 122 to provide their credentials (e.g., user names, passwords). In some embodiments, upon authentication, requests associated with the plurality of users 122 (e.g., search requests, purchase requests, account review requests, item recommendation requests) are received from the workstation(s) 106 and user computing devices 110, 112 and 114.

The network environment 100 is implemented to enable secure concurrent access experience by multiple users 122 of the user application. User interactions (e.g., queries, actions, etc.) of the plurality of users 122 are managed in a centralized manner by the computing device 102 and/or the cloud-based engine 121. In some embodiments, the computing device 102 and/or the cloud-based engine 121 may obtain one or more query messages provided by a first user in a natural language format and process the one or more query messages using a natural language processing model to generate a user request for modifying a target information list with basic item information of one or more items. In response to the user request, the computing device 102 and/or the cloud-based engine 121 may generate one or more candidate information items representing a subset of a plurality of information lists available to the first user 122A. While the one or more candidate information items are presented to the first user 122A, the computing device 102 and/or the cloud-based engine 121 may receive a user input selecting a target information item representing the target information list. The computing device 102 and/or the cloud-based engine 121 may update the target information list based on the basic item information that is generated by processing the one or more query messages and store the target information list updated based on the basic item information in the memory.

FIG. 2 is a block diagram of a computing device 200, in accordance with some embodiments of the present teaching. In some embodiments, each of the computing device 102, the web server 104, the workstation(s) 106, the user computing devices 110, 112, 114, and/or the one or more processing devices 120 in FIG. 1 may include the features shown in FIG. 2. Referring to FIG. 2, the computing device 200 includes one or more of: one or more processors 201, a working memory 202, one or more input/output (I/O) devices 207, an instruction memory 203, a transceiver 204, one or more communication ports 209, a display 206 with a user interface 205, and an optional location device 211, all operatively coupled to one or more data buses 208. The data buses 208 allow for communication among the various devices. The data buses 208 may include wired, or wireless, communication channels.

The processors 201 may include one or more distinct processors, each having one or more cores. Each of the distinct processors may have the same or different structure. The processors 201 may include one or more central processing units (CPUs), one or more graphics processing units (GPUs), application specific integrated circuits (ASICs), digital signal processors (DSPs), and the like.

The instruction memory 203 may store instructions that may be accessed (e.g., read) and executed by the processors 201. For example, the instruction memory 203 may be a non-transitory, computer-readable storage medium such as a read-only memory (ROM), an electrically crasable programmable read-only memory (EEPROM), flash memory, a removable disk, CD-ROM, any non-volatile memory, or any other suitable memory. The processors 201 may be configured to perform a certain function or operation by executing code, stored on the instruction memory 203, embodying the function or operation. For example, the processors 201 may be configured to execute code stored in the instruction memory 203 to perform one or more of any function, method, or operation disclosed herein.

Additionally, the processors 201 may store data to, and read data from, the working memory 202. For example, the processors 201 may store a working set of instructions to the working memory 202, such as instructions loaded from the instruction memory 203. The processors 201 may also use the working memory 202 to store dynamic data created during the operation of the computing device 102. The working memory 202 may be a random access memory (RAM) such as a static random access memory (SRAM) or dynamic random access memory (DRAM), or any other suitable memory.

The input-output devices 207 may include any suitable device that allows for data input or output. For example, the input-output devices 207 may include one or more of a keyboard, a touchpad, a mouse, a stylus, a touchscreen, a physical button, a speaker, a microphone, or any other suitable input or output device.

The communication port(s) 209 may include, for example, a serial port such as a universal asynchronous receiver/transmitter (UART) connection, a Universal Serial Bus (USB) connection, or any other suitable communication port or connection. In some examples, the communication port(s) 209 allows for the programming of executable instructions in the instruction memory 203. In some examples, the communication port(s) 209 allow for the transfer (e.g., uploading or downloading) of data, such as model training data.

The display 206 may be any suitable display, and may display the user interface 205. The user interfaces 205 may enable user interaction with the computing device 102. For example, the user interface 205 may be a user interface for an application of a retailer that allows a customer to view and interact with a retailer's website. In some examples, a user may interact with the user interface 205 by engaging the input-output devices 207. In some examples, the display 206 may be a touchscreen, where the user interface 205 is displayed on the touchscreen.

The transceiver 204 allows for communication with a network, such as the communication network 118 of FIG. 1. For example, if the communication network 118 of FIG. 1 is a cellular network, the transceiver 204 is configured to allow communications with the cellular network. In some examples, the transceiver 204 is selected based on the type of the communication network 118 the computing device 102 will be operating in. The processor(s) 201 is operable to receive data from, or send data to, a network, such as the communication network 118 of FIG. 1, via the transceiver 204.

The optional location device 211 may be communicatively coupled to one or more location services and/or devices and operable to receive position data from the corresponding location services. For example, the location device 211 may receive position data identifying a latitude, and longitude, from a satellite of a positioning constellation. Based on the position data, the computing device 102 may determine a local geographical area (e.g., town, city, state, etc.) of its position.

In some embodiments, the computing device 200 is configured to implement a user application for a plurality of users 122 via service deployment, service execution, self-learning and fine tuning, and session knowledge enrichment. In some embodiments, the working memory 203, or alternatively the non-transitory computer readable storage medium of memory 202, stores the following programs, modules and data structures, instructions, or a subset thereof:
Operating system 212 that includes procedures for handling various basic system services and for performing hardware dependent tasks;
Communication module 214 that is used for connecting the computing device 200 to other machines (e.g., other devices 102, 104, 120, 106, 110, 112, 114, and/or 116 in the network environment 100) via one or more network communication ports 209 (wired or wireless) and one or more communication networks 118, such as the Internet, other wide area networks, local area networks, metropolitan area networks, and so on;
I/O module 216 that includes procedures for handling various basic input and output functions through one or more input and output devices;
User application 218 that is executed to provide server-side functionalities, where in some embodiments, the user application 218 is an online interface application that may have a plurality of user accounts 220 associated with to registered and/or guest users 122, keep a plurality of information lists 222 for each user account 220, and provide online services via the registered and/or guest users 122 based on the plurality of information lists 222;
Information processing module 224 that is executed to obtain one or more query messages having a natural language format; process the one or more query messages using a natural language processing model 226 to generate a user request for modifying a target information list with basic item information, identify the target information list from the plurality of information lists 222, and update the target information list based on the basic item information; and
Item database 228 for storing data items representative of items included in a catalog of a user application 218 executed on a cloud-base information platform, where in some embodiments, the item database 228 is included in the database 116 (FIG. 1).

In some embodiments, for each user account 220 associated with a respective user 122, the plurality of information lists 222 includes a predefined information list 222P and one or more custom information lists 222C. The predefined information list 222P may be named with a first semantic term (e.g., “cart”) for all of the plurality of user accounts 220 and configured to include only specific item information of one or more items in an item database 228. An example of the specific item information associated with an item is “Brand X 20 FL OZ Bottle Vitamin Water Zero Sugar,” which may be found in the item database 228. The one or more items on the predefined information list 222P may be ordered upon a user confirmation, and the cloud-based information platform may enable online or offline operations to facilitate delivery of the one or more items on the predefined information list 222P. Further, the one or more custom information lists 222C may be customized for each user account 220 and configured to include either generic item information that correspond to an item type of items in the item database 228 or the specific item information. Items in each custom information list 222C may need to be moved to the predefined information list 222P to be ordered. An example of the generic item information associated with an item is “Vitamin Water” in a custom information list 222C. In some embodiments, the one or more custom information lists 222C include one or more default information lists, e.g., “Weekly Shopping List” and “Christmas Gift List,” as set forth by the cloud-based information platform for the plurality of user accounts 220. The one or more default information lists 222D may be automatically created as a respective user account 220 is registered. Among the custom information lists 222C, a remaining user-created information list 222U distinct from the one or more default information lists may be created in response to a user request of a respective user 122.

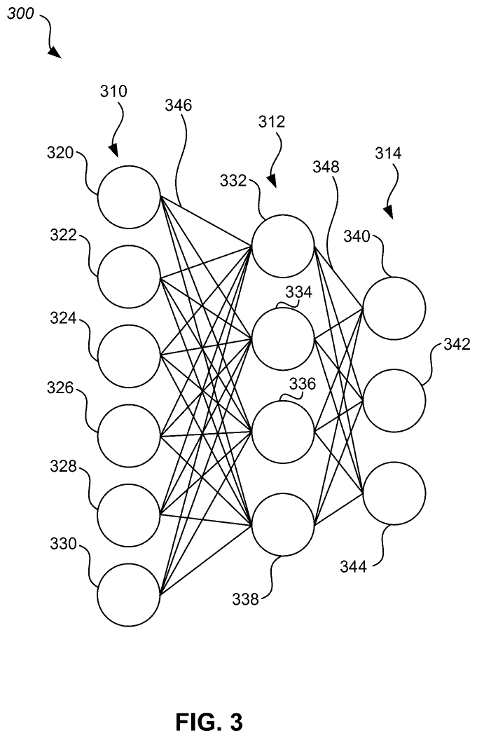

FIG. 3 illustrates an artificial neural network 300, in accordance with some embodiments. Alternative terms for “artificial neural network” are “neural network,” “artificial neural net,” “neural net,” or “trained function.” The neural network 300 comprises nodes 320-344 and edges 346-348, wherein each edge 346-348 is a directed connection from a first node 320-338 to a second node 332-344. In general, the first node 320-338 and the second node 332-344 are different nodes, although it is also possible that the first node 320-338 and the second node 332-344 are identical. For example, in FIG. 3 the edge 346 is a directed connection from the node 320 to the node 332, and the edge 348 is a directed connection from the node 332 to the node 340. An edge 346-348 from a first node 320-338 to a second node 332-344 is also denoted as “ingoing edge” for the second node 332-344 and as “outgoing edge” for the first node 320-338.

The nodes 320-344 of the neural network 300 may be arranged in layers 310-314, wherein the layers may comprise an intrinsic order introduced by the edges 346-348 between the nodes 320-144 such that edges 346-348 exist only between neighboring layers of nodes. In the illustrated embodiment, there is an input layer 310 comprising only nodes 320-330 without an incoming edge, an output layer 314 comprising only nodes 340-344 without outgoing edges, and a hidden layer 312 in-between the input layer 310 and the output layer 314. In general, the number of hidden layer 312 may be chosen arbitrarily and/or through training. The number of nodes 320-330 within the input layer 310 usually relates to the number of input values of the neural network, and the number of nodes 340-344 within the output layer 314 usually relates to the number of output values of the neural network.

In particular, a (real) number may be assigned as a value to every node 320-344 of the neural network 300. Here,

$${x}_{i}^{( n )}$$

denotes the value of the 1-th node 320-344 of the n-th layer 310-314. The values of the nodes 320-330 of the input layer 310 are equivalent to the input values of the neural network 300, the values of the nodes 340-344 of the output layer 314 are equivalent to the output value of the neural network 300. Furthermore, each edge 346-348 may comprise a weight being a real number, in particular, the weight is a real number within the interval [−1, 1], within the interval [0, 1], and/or within any other suitable interval. Here,

$${w}_{i , j}^{( m , n )}$$

denotes the weight of the edge between the i-th node 320-338 of the m-th layer 310, 312 and the j-th node 332-344 of the n-th layer 312, 314. Furthermore, the abbreviation

$${w}_{i , j}^{( n )}$$

is defined for the weight

$${w}_{i , j}^{( n , n + 1 )} .$$

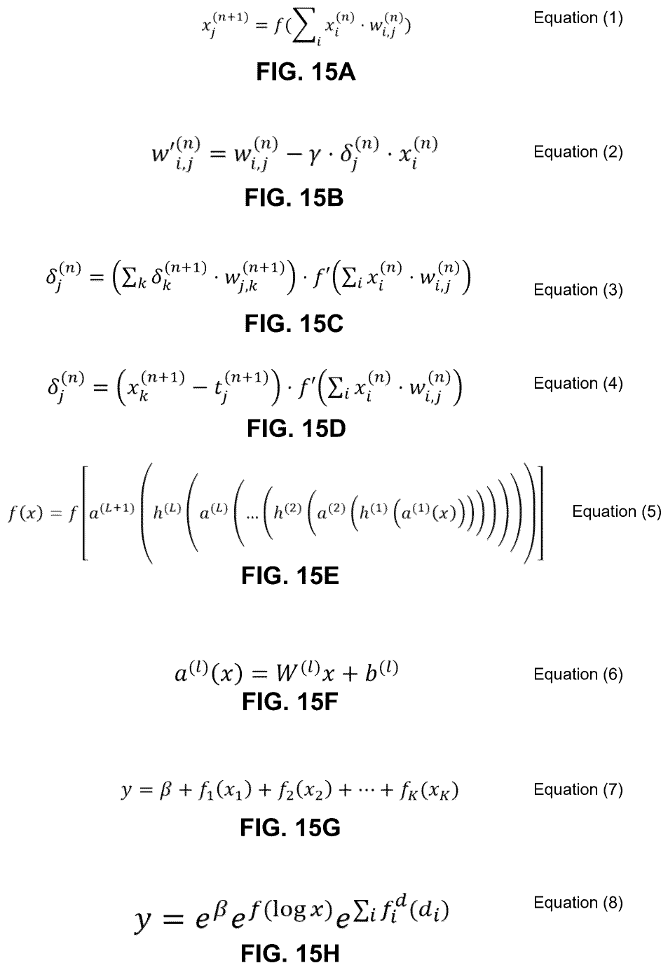

In particular, to calculate the output values of the neural network 300, the input values are propagated through the neural network. In particular, the values of the nodes 332-344 of the (n+1)-th layer 312, 314 may be calculated based on the values of the nodes 320-338 of the n-th layer 310, 312 by equation (1) in FIG. 15A, where the function f is a transfer function (another term is “activation function”). Known transfer functions are step functions, sigmoid function (e.g., the logistic function, the generalized logistic function, the hyperbolic tangent, the Arctangent function, the error function, the smooth step function) or rectifier functions. The transfer function is mainly used for normalization purposes.

In particular, the values are propagated layer-wise through the neural network, wherein values of the input layer 310 are given by the input of the neural network 300, wherein values of the hidden layer(s) 312 may be calculated based on the values of the input layer 310 of the neural network and/or based on the values of a prior hidden layer, etc.

In order to set the values

$${w}_{i , j}^{( m , n )}$$

for the edges, the neural network 300 has to be trained using training data. In particular, training data comprises training input data and training output data. For a training step, the neural network 300 is applied to the training input data to generate calculated output data. In particular, the training data and the calculated output data comprise a number of values, said number being equal with the number of nodes of the output layer.

In particular, a comparison between the calculated output data and the training data is used to recursively adapt the weights within the neural network 300 (backpropagation algorithm). In particular, the weights are changed according to equation (2) in FIG. 15B, where γ is a learning rate, and the numbers

$${δ}_{j}^{( n )}$$

may be recursively calculated as equation (3) in FIG. 15C based on

$${δ}_{j}^{( n + 1 )} ,$$

if the (n+1)-th layer is not the output layer, and equation (4) in FIG. 15D if the (n+1)-th layer is the output layer 34, wherein f is the first derivative of the activation function, and

$${y}_{j}^{( n + 1 )}$$

is the comparison training value for the j-th node of the output layer 314.

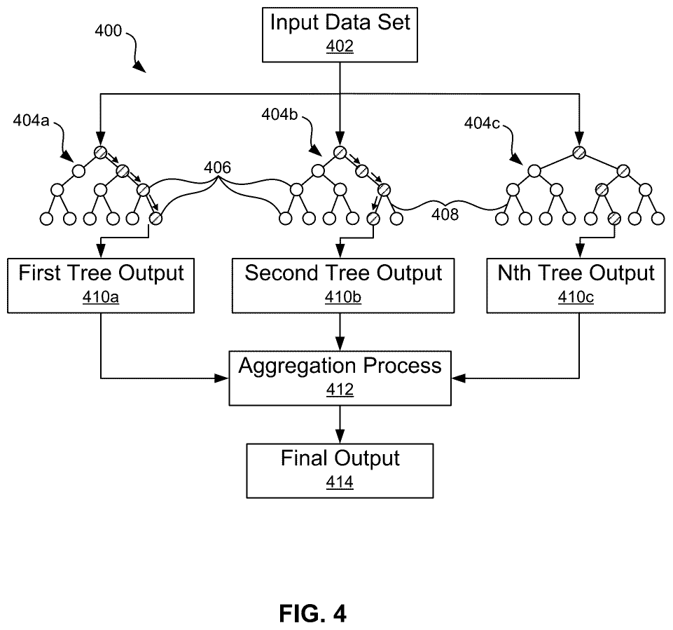

FIG. 4 illustrates a tree-based neural network 400, in accordance with some embodiments. In particular, the tree-based neural network 400 is a random forest neural network, though it will be appreciated that the discussion herein is applicable to other decision tree neural networks. The tree-based neural network 400 includes a plurality of trained decision trees 404a-404c each including a set of nodes 406 (also referred to as “leaves”) and a set of edges 408 (also referred to as “branches”).

Each of the trained decision trees 404a-404c may include a classification and/or a regression tree (CART). Classification trees include a tree model in which a target variable may take a discrete set of values, e.g., may be classified as one of a set of values. In classification trees, each leaf 406 represents class labels and each of the branches 408 represents conjunctions of features that connect the class labels. Regression trees include a tree model in which the target variable may take continuous values (e.g., a real number value).

In operation, an input data set 402 including one or more features or attributes is received. A subset of the input data set 402 is provided to each of the trained decision trees 404a-404c. The subset may include a portion of and/or all of the features or attributes included in the input data set 402. Each of the trained decision trees 404a-404c is trained to receive the subset of the input data set 402 and generate a tree output value 410a-410c, such as a classification or regression output. The individual tree output value 410a-410c is determined by traversing the trained decision trees 404a-404c to arrive at a final leaf (or node) 406.

In some embodiments, the tree-based neural network 400 applies an aggregation process 412 to combine the output of each of the trained decision trees 404a-404c into a final output 414. For example, in embodiments including classification trees, the tree-based neural network 400 may apply a majority-voting process to identify a classification selected by the majority of the trained decision trees 404a-404c. As another example, in embodiments including regression trees, the tree-based neural network 400 may apply an average, mean, and/or other mathematical process to generate a composite output of the trained decision trees. The final output 414 is provided as an output of the tree-based neural network 400.

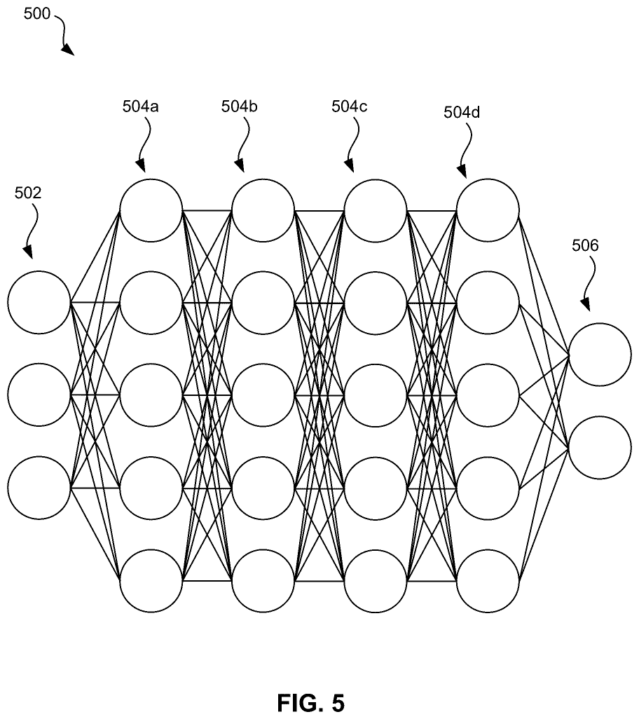

FIG. 5 illustrates a deep neural network (DNN) 500, in accordance with some embodiments. The DNN 500 is an artificial neural network, such as the neural network 300 illustrated in conjunction with FIG. 3, that includes representation learning. The DNN 500 may include an unbounded number of (e.g., two or more) intermediate layers 504a-504d each of a bounded size (e.g., having a predetermined number of nodes), providing for practical application and optimized implementation of a universal classifier. Each of the layers 504a-504d may be heterogenous. The DNN 500 may be configured to model complex, non-linear relationships. Intermediate layers, such as intermediate layer 504c, may provide compositions of features from lower layers, such as layers 504a, 504b, providing for modeling of complex data.

In some embodiments, the DNN 500 may be considered a stacked neural network including multiple layers each configured to execute one or more computations. The computation for a network with L hidden layers may be denoted as equation (5) in FIG. 15E, where a^{(l)}(x) is a preactivation function and h^{(l)}(x) is a hidden-layer activation function providing the output of each hidden layer. The preactivation function a^{(l)}(x) may include a linear operation with matrix W^{(l)} and bias b^{(l)} according to equation (6) in FIG. 15F.

In some embodiments, the DNN 500 is a feedforward network in which data flows from an input layer 502 to an output layer 506 without looping back through any layers. In some embodiments, the DNN 500 may include a backpropagation network in which the output of at least one hidden layer is provided, e.g., propagated, to a prior hidden layer. The DNN 500 may include any suitable neural network, such as a self-organizing neural network, a recurrent neural network, a convolutional neural network, a modular neural network, and/or any other suitable neural network.

In some embodiments, a DNN 500 may include a neural additive model (NAM). An NAM includes a linear combination of networks, each of which attends to (e.g., provides a calculation regarding) a single input feature. For example, a NAM may be represented as equation (7) in FIG. 15G, where β is an offset and each fi is parametrized by a neural network. In some embodiments, the DNN 500 may include a neural multiplicative model (NMM), including a multiplicative form for the NAM mode using a log transformation of the dependent variable y and the independent variable x according to equation (8) in FIG. 15H, where d represents one or more features of the independent variable x.

It will be appreciated that information list updating, as disclosed herein, particularly for large platforms such as e-commerce network platforms, is only possible with the aid of computer-assisted machine-learning algorithms and techniques, such as the natural language processing model 226. In some embodiments, information list updating processes including the trained natural language processing model 226 are used to perform operations that cannot practically be performed by a human, either mentally or with assistance. Such operations include, but not limited to, recognizing basic item information associated with the one or more items and information of a target information list. The information of the target information list is applied to identify a subset of a plurality of information lists available to a user. Additionally, the one or more items may be selected from a plurality of items for which item information is stored in a database (e.g., database 116 in FIG. 1, item database 228 in FIG. 2). In some situations, the database stores information of millions of items, which cannot practically be processed by a human. It will be appreciated that a variety of information list updating techniques may be used alone or in combination to exact the item information, the information of the target information list, and the user request from one or more natural language query messages and select a single target information list to be updated with specific or generic item information accordingly.

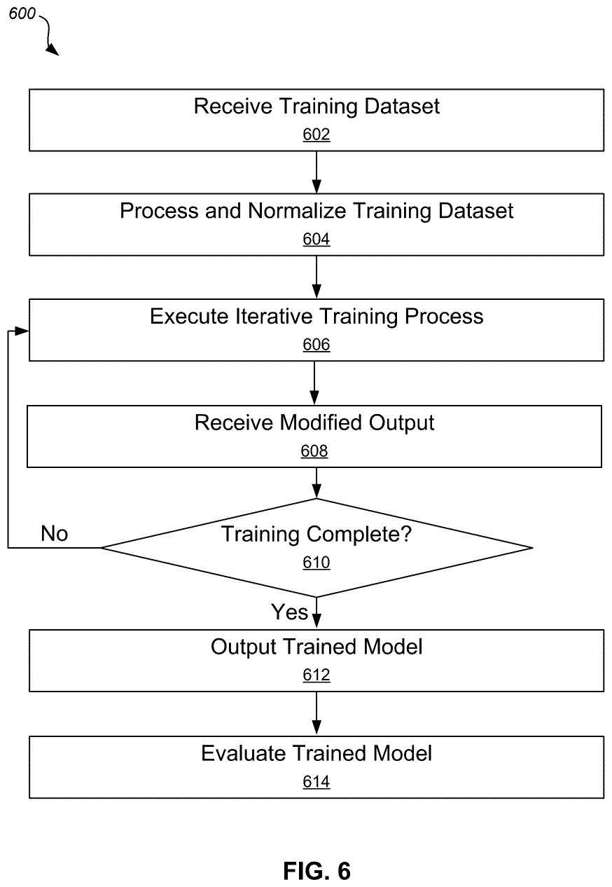

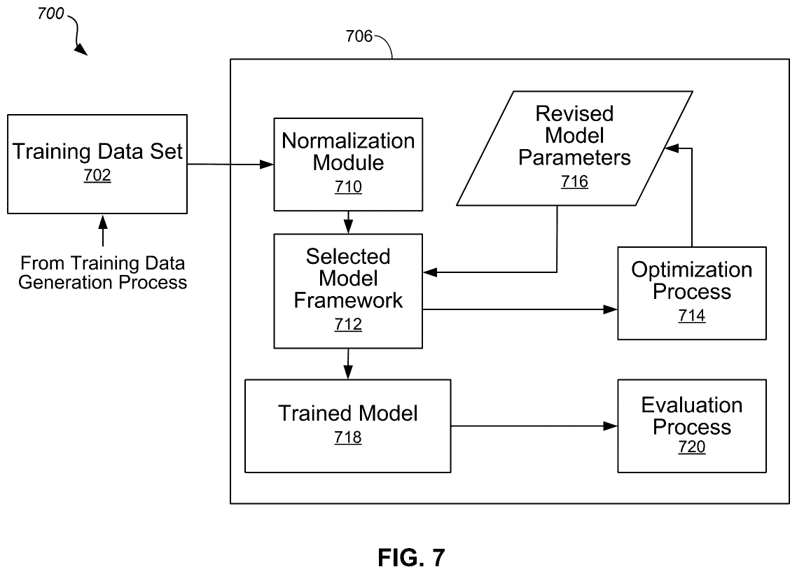

In some embodiments, an information list updating method may include and/or implement one or more trained models, such as a natural language processing model 226. In some embodiments, one or more trained models may be generated using an iterative training process based on a training dataset. FIG. 6 illustrates a method 600 for generating a trained model, such as a trained optimization model, in accordance with some embodiments. FIG. 7 is a process flow 700 illustrating various steps of the method 600 of generating a trained model (e.g., a trained natural language processing model 226 in FIG. 2), in accordance with some embodiments. At step 602, a training dataset 702 is received by a system 706, such as a processing device 120. The training dataset 702 may include labeled and/or unlabeled data. For example, in some embodiments, a set of training data is provided for use in training a model, as discussed above.

At optional step 604, the received training dataset 702 is processed and/or normalized by a normalization module 710. For example, in some embodiments, the training dataset 702 may be augmented by imputing or estimating missing values or features of one or more screenshots.

At step 606, an iterative training process is executed to train a selected model framework 712. The selected model framework 712 may include an untrained (e.g., base) natural language processing model 226, such as a DNN-based framework and/or a partially or previously trained model (e.g., a prior version of a trained model). The training process is configured to iteratively adjust parameters (e.g., hyperparameters) of the selected model framework 712 to minimize a cost value (e.g., an output of a cost function) for the selected model framework 712.

At step 608, the training process is an iterative process that generates set of revised model parameters 716 and the output of the cost function during each iteration. The set of revised model parameters 716 may be generated by applying an optimization process 714 to the cost function of the selected model framework 712. The optimization process 714 may be configured to reduce the cost value (e.g., reduce the output of the cost function) at each step by adjusting one or more parameters during each iteration of the training process.

After each iteration of the training process, at step 610, a determination is made whether the training process is complete. The determination at step 610 may be based on any suitable parameters. For example, in some embodiments, a training process may complete after a predetermined number of iterations. As another example, in some embodiments, a training process may complete when it is determined that the cost function of the selected model framework 712 has reached a minimum, such as a local minimum and/or a global minimum.

At step 612, a trained model 718 is output and provided for use in determining query-item ranking and/or ranking items. At optional step 614, a trained model 718 may be evaluated by an evaluation process 720. A trained model may be evaluated based on any suitable metrics, such as, for example, an F or FI score, normalized discounted cumulative gain (NDCG) of the model, mean reciprocal rank (MRR), mean average precision (MAP) score of the model, and/or any other suitable evaluation metrics. Although specific embodiments are discussed herein, it will be appreciated that any suitable set of evaluation metrics may be used to evaluate a trained model.

Although the methods described above are with reference to the illustrated flowcharts, it will be appreciated that many other ways of performing the acts associated with the methods may be used. For example, the order of some operations may be changed, and some of the operations described may be optional.

In addition, the methods and system described herein may be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods may be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

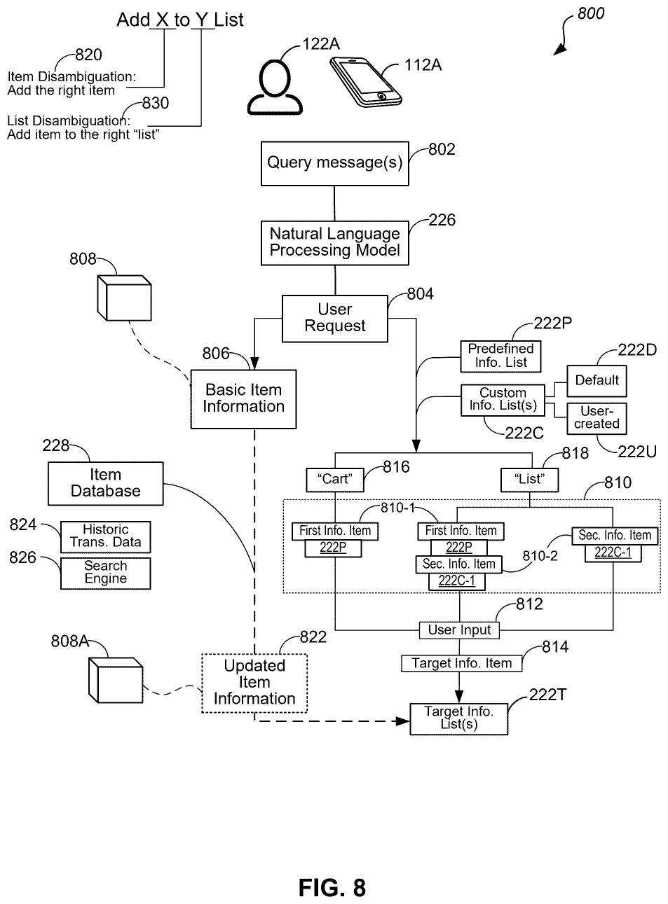

FIG. 8 is a flow diagram of a process 800 of updating a target information list 222T in response to one or more query messages 802 of a first user 122A, in accordance with some embodiments. The process 800 may be implemented by any suitable system (e.g., including a computing device 102 and/or a cloud-based engine 121 in FIG. 1). A user application 218 (FIG. 2) may be associated with a plurality of users 122 (e.g., registered users, guest users) and/or have a plurality of user accounts 220. While the user application 218 is executed, one or more query messages 802 are collected via an electronic device 112A associated with the first user 122A. The one or more query messages 802 have a natural language format and are processed using a natural language processing model 226 (FIG. 2) to generate a user request 804 for modifying the target information list 222T with basic item information 806 of one or more items 808. The user request 804 may include basic item information 806 associated with the one or more items 808. In response to the user request 804, one or more candidate information items 810 are generated to represent a subset of a plurality of information lists 222 available to the first user 122A. While the one or more candidate information items 810 are presented to the first user 122A, a user input 812 is received for identifying or selecting a target information item 814 representing the target information list 222T. The target information list 222T is updated based on the basic item information 806 that is generated by processing the one or more query messages 802. The target information list 222T updated based on the basic item information is stored in memory (e.g., any information list 222 in FIG. 2). As such, the target information list 222T is identified, updated, and stored for a user account 220 associated with the first user 122A.

In a non-limiting example, one or more query messages 802 provided by the first user 122A include “add an item X to a Y list.” The process 800 includes an item disambiguation process 820 for clarifying item information to be updated for the target information list 222T and a list disambiguation process 830 for clarifying the target information list 222T to receive the clarified item information. Particularly, the list disambiguation process 830 may identify different types of the target information list 222T (e.g., predefined information list 222P, custom information list 222C), which may require different types of item information (e.g., specific or generic item information) to be added to the target information list 222T. In some embodiments, for the user account 220 associated with the first user 122A, the plurality of information lists 222 include a predefined information list 222P and one or more custom information lists 222C. The predefined information list 222P may be named with a first semantic term (e.g., “cart”) for all of the plurality of user accounts 220 and configured to include only specific item information of one or more items that may be found in the item database 228 (FIG. 2). Further, the one or more custom information lists 222C may be customized for the first user 122A and configured to include generic item information, the specific item information, or both. The generic item information may correspond to one or more items of a certain type in the item database 228. In some embodiments, the one or more custom information lists 222C includes one or more default information lists 222D, e.g., “Weekly Shopping List” and “Christmas Gift List,” as set forth by the cloud-based information platform for each user account 220. The customer information lists 222C may further include a user-created information list 222U distinct from the one or more default information lists 222D.

In some situations, the one or more query messages 802 (e.g., “add vitamin water to cart”) include a first semantic term 816 (e.g., “cart”) and the one or more candidate information items 810 includes a first information item 810-1 representing the predefined information list 222P of the first user 122A. The predefined information list 222P is identified as the target information list 222T. Items on the predefined information list 222P may be ordered upon a user confirmation, and the cloud-based information platform may enable online or offline operations to facilitate delivery of the items on the predefined information list 222P to the first user 122A. Further, in some embodiments, the predefined information list 222P has an item information condition requiring that the basic item information 806 be added to the predefined information list 222P (which is identified as the target information list 222T) in accordance with a determination that the basic item information 806 matches information of individual items in an item database 228 (e.g., in a database 116). Conversely, in some embodiments, the basic item information 806 does not match information of individual items in the item database 228, and an updated item information associated with an individual item is identified in the item database 228 and added to the target information list 222T (e.g., the predefined information list 222P).

Alternatively, in some situations, the one or more query messages 802 (e.g., “add cabbage to my weekly shopping list”) include identification information of a first custom information list 222C-1 (e.g., weekly shopping list), and the user request 804 identifies the first custom information list 222C-1 as the target information list 222T. There is no ambiguity with the target information list 222T. The one or more candidate information items 810 (e.g. a second information item 810-2) include at least the target information item 814 representing the target information list 222T. Further, in some embodiments, the natural language processing model 226 includes a classifier configured to, in response to the one or more query messages 802, extract the user request 804 identifying the first custom information list 222C-1 as the target information list 222T. The target information item 814 representing the target information list 222T may be included in the one or more candidate information items 810 and selected by the user input 812, (e.g., as an only candidate).

Alternatively and additionally, in some situations, the one or more query messages 802 may include a second semantic term 818 (e.g., “list”). The first user 212A may use it to refer to both a custom information list 222C and a predefined information list 222P without differentiating them. As explained above, the predefined information list 222P may be associated with a virtual shopping cart and configured to include only specific item information of one or more items in the item database 228. The one or more custom information lists 222C may act as a checklist that are not processed immediately, and include generic item information or specific item information. In response to the user request 804, the one or more candidate information items 810 may be generated to include a first information item 810-1 identifying the predefined information list 222P and a second information item 810-2 identifying at least one of the one or more custom information lists 222C. Further, in some embodiments, the natural language processing model 226 may include a classifier configured to generate the user request 804 for both the predefined information list 222P and the one or more custom information lists 222C in response to the one or more query messages 802 including the second semantic term 818. The at least one of the one or more custom information lists 222C is selected based on the one or more query messages 802.

In some embodiments, when the one or more query messages 802 includes the second semantic term 818 (e.g., “list”), the user input 812 selects the second information item 810-2 identifying the at least one of the one or more custom information lists 222C as the target information item 814. The basic item information 806 (e.g., “soda”) identified with the user request 804 may be added to the target information list 222T (e.g., a weekly shopping list), independently of whether the basic item information matches information of individual items in an item database. Conversely, in some embodiments, the target information list 222T includes a custom information list 222C, and specific item information corresponding to an item in the item database 228 is still identified based on the basic item information 806 and applied to update the target information list 222T.

While the list disambiguation process 830 clarifies the target information list 222T, the item disambiguation process 820 clarifies item information updated to the target information list 222T. In some embodiments, the basic item information 806 generated from the one or more query messages 802 may be associated with a target item 808A for which specific item information is stored in the item database 228, and therefore, be updated based on the specific item information of the target item 808A to generate updated item information 822. The updated item information 822 is added into the target information list 222T. In some embodiments, in accordance with a determination that the target information list 222T corresponds to a predefined information list 222P, the basic item information 806 generated from the one or more query messages 802 may be associated with the target item 808A. Conversely, in some embodiments, the target information list 222T may be one of a plurality of custom information lists 222C. It is noted that when the target information list 222T is a custom information list 222C, the basic item information 806 may be directly added to the target information list 222T without referring to the target item 808A.

Further, in some embodiments, the target item 808A may be identified based on historic transaction data 824 of the first user 122A. Alternatively, in some embodiments, in accordance with a determination that historic transaction data 824 of the first user 122A does not match the basic item information 806, a search request is generated based on the one or more query messages 802 or the basic item information 806 generated from the one or more query messages 802, and provided to an item search engine 826 to identify the target item 808A for which the specific item information is stored in the item database 228.

In some embodiments of this application, the process 800 allows users 122 to quickly add items to a designated list 222C or the predefined information list 222P, e.g., with voice interaction and limited user interactions. Two types of information lists 222 are applied, and particularly, multiple custom information lists 222C may be presented jointly and/or with the predefined information list 222P as options from which the target information list 222T is selected. The item disambiguation process 820 further personalizes choice of items automatically, e.g., based on historic transaction data 824, using the item search engine 826.

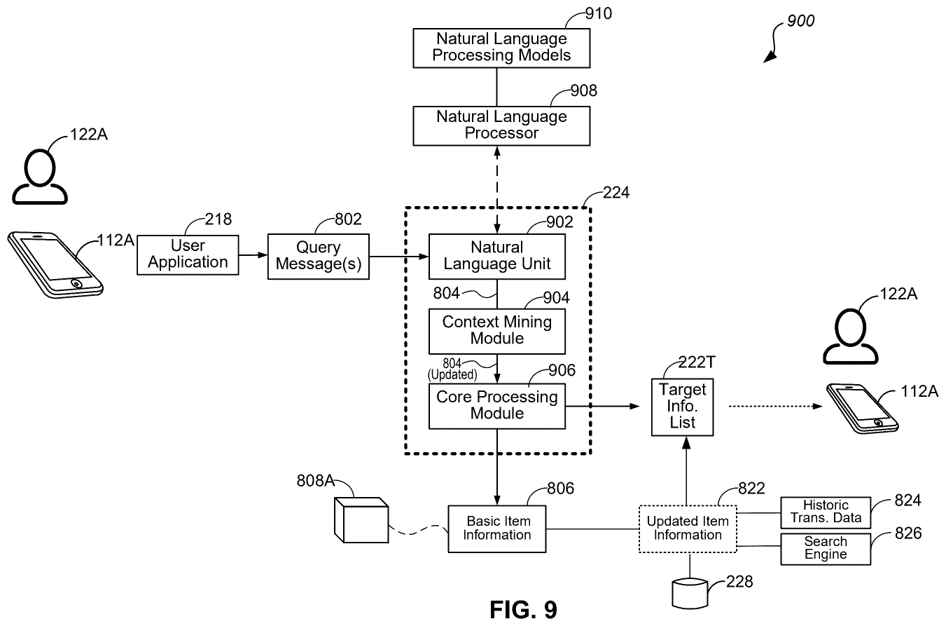

FIG. 9 is a block diagram of an information processing system 900, in accordance with some embodiments. The information processing system 900 may be any suitable system (e.g., including a computing device 102 and/or a cloud-based engine 121 in FIG. 1) configured to process natural language query message(s) 802 provided by a first user 122A and update a target information list 222T. A user application 218 is executed to enable display of a user interface on an electronic device 112A associated with the first user 122A. The first user 122A enters one or more query messages 802 via the user interface. The query message(s) 802 have a natural language format that follows naturally developed language rules in use. In some embodiments, the one or more query messages 802 may be entered as one or more audio signals via a microphone of the electronic device 112A. Alternatively, in some embodiments, each of the one or more query messages 802 is a textual message entered on the user interface by the first user 122A. In some situations, the one or more query messages 802 may include at least one of a plurality of predefined key words (e.g., “cart,” “list”), and each predefined key word corresponds to a respective set of one or more candidate information items 810 (FIG. 8) representing corresponding information lists 222. The information processing system 900 may further include an information processing module 224 (see FIG. 2). The information processing module 224 is coupled to the user application 218 and configured to generate a user request 804 including basic item information 806 and update the target information list 222T based on the basic item information 806.

In some embodiments, the information processing module 224 further includes a natural language unit (NLU) 902, a context mining module 904, and a core processing module 906. Further, in some embodiments, the information processing module 224 includes a natural language model 226. The natural language unit 902 applies the natural language model 226 to process each of the one or more query messages 802 and determine the user request 804 including the basic item information 806. Alternatively, in some embodiments, the information processing module 224 does not include a natural language model 226 or chooses not to use its own natural language model 226. The natural language unit 902 provides information of the query message(s) 802 to a natural language processor 908 dedicated to natural language processing. The natural language processor 908 may include an internal module distinct from the information processing module 224 or a third-party service module. The natural language processor 908 may process the information of the query message(s) 802 using one or more natural language processing models 910 and determine the user request 804 including the basic item information 806 and one or more candidate information items 810 representing a subset of a plurality of information lists 222.

In some embodiments, the one or more query messages 802 may include a sequence of two or more query messages in the natural language format. The context mining module 904 is coupled to the natural language unit 902 and may correlate the two or more query messages in the sequence with one another. The context mining module 904 may generate a context including a plurality of context terms by processing each of the sequence of two or more query messages using the natural language processing model 226 separately. Alternatively, the context mining module 904 may generate the context including the associated context terms based on the query message(s) 802 or information of the user request 804 provided by the natural language unit 902. The user request 804 generated by the natural language unit 902 may be further adjusted and improved based on the context. Stated another way, the user request 804 may be generated as a result of natural language processing and context mining. In some embodiments, the sequence of two or more query messages has the same conversation identifier. In some embodiments, two or more query messages 802 are recorded in two or more audio signals in two or more sessions. Alternatively, in some embodiments, the two or more query messages 802 are continuously recorded in a single audio signal and in a single session. In some embodiments, the natural language processing model 226 is trained to understand a user's utterance habits, and extracts the context associated with the user's utterance habits based on the sequence of two or more query messages 802. The sequence of two or more query messages 802 may be successive to one another or separated by an irrelevant messages in between.

In some embodiments, the core processing module 906 receives the user request 804 including the basic item information 806 and updates the target information list 222T with the basic item information 806 directly, e.g., for a custom information list 222C, which does not need to identify a specific item 808 yet. Alternatively, in some embodiments, the core processing module 906 receives the user request 804 and updates the target information list 222T adaptively based on the basic item information 806, e.g., for a predefined information list 222P or a custom information list 222C. The user request 804 includes the basic item information 806. For example, the basic item information 806 generated from the one or more query messages 802 includes generic item information of “Flavored Water,” and the updated item information 822 includes specific item information of “Brand X 20 FL OZ Bottle Flavored Water Zero Sugar.” In another example, the update item information 822 includes an identification number corresponding to a specific product in the item database 228 (FIG. 2).

In some embodiments, the basic item information 806 generated from the one or more query messages 802 is associated with a target item 808A for which specific item information is stored in the item database 228. The basic item information 806 may be updated based on the specific item information of the target item 808A to generate updated item information 822. The updated item information 822 including the specific item information is added into the target information list 222T, e.g. into a predefined information list 222P or a custom information list 222C. Further, in some embodiments, the target item 808A may be identified based on historic transaction data 824 of a first user 122A. Alternatively, in some embodiments, in accordance with a determination that historic transaction data 824 of the first user 122A does not match the basic item information 806 (e.g., because the first user 122A never purchased the target item 808A), a search request is generated based on the one or more query messages 802 or the basic item information 806 generated from the one or more query messages 802, and in response to the search request, an item search engine 826 (FIG. 8) searches in the item database 228 to identify the target item 808A for which the specific item information is stored in the item database 228.

In some embodiments, the updated target information list 222T may be stored, in a database 116, in association with a user account 220 associated with the first user 122A. The updated target information list 222T may be extracted for further review or processing. For example, the first user 122A may update the Christmas Gift List during the entire year, and pull out the Christmas Gift List to move all items on the list to a predefined information list 222P (e.g., corresponding to a virtual shopping cart) in December of a year. In some embodiments, a user application 218 is executed to display a user interface on an electronic device 112A associated with the first user 122A, and the updated target information list 222T is displayed on the user interface. The first user 122A may perform an operation (e.g., add, select, modify, or delete an item) on the updated information list 222T.

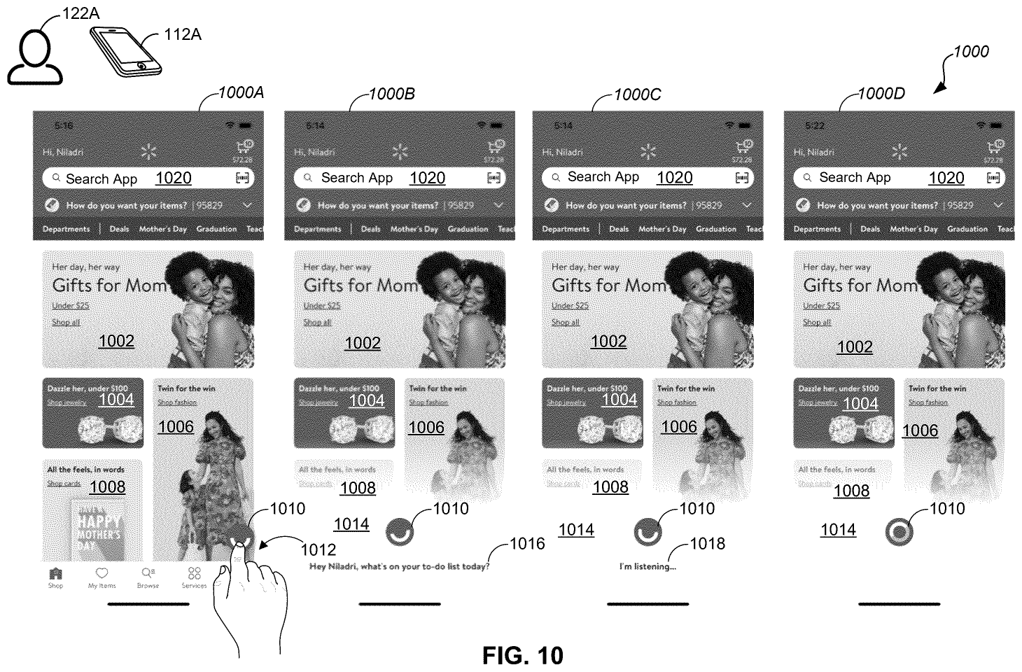

FIG. 10 is a diagram illustrating a set of graphical user interfaces 1000 (e.g., 1000A-1000D) displayed for receiving and processing natural language query messages 802, in accordance with some embodiments. A user application 218 is executed, and displays user interfaces 1000A-1000D, on an electronic device 112A associated with a first user 122A. Each of the user interfaces 1000A-1000D is selected from: a content page, an order detail page, an account setting page, a product landing page, and an item detail page. Referring to FIG. 10, each user interface 1000 may be a content page including four regions 1002, 1004, 1006, and 1008 where four advertisements are displayed. The user interface 1000A includes a voice assistant affordance item 1010 overlaid on top of a region 1006 and overlaps content of an advertisement displayed in the region 1006. The voice assistant affordance item 1010A may be displayed on the user interface 1000, independently of content concurrently displayed on the user interface 1000A (e.g., when the user interface 1000A is any of a content page, an order detail page, an account setting page, a product landing page, and an item detail page). In some embodiments, the voice assistance affordance item 1010 may be dragged to any position of the user interface 1000A.

In some embodiments, while the voice assistance affordance item 1010 is displayed on the user interface 1000A, a user action 1012 (e.g., a click) is detected on the voice assistance affordance item 1010, In response to detection of the user action 1012, a voice assistance mode is enabled, and a microphone of the electronic device 112A is activated to collect an audio signal. In some embodiments, while the microphone is activated with a voice assistance mode, a focus region 1014 is enabled on the user interfaces 1000B-1000D, e.g., covering a subset of the regions 1002-1008 displaying the advertisements. The voice assistance affordance item 1010 is displayed on the focus region 1014. The user interface 1010B may further display a prompt 1016 (e.g., “Hey, Niladri, what's on your to-do-list today?”) on the focus region 1014, and the prompt 1016 may be concurrently broadcast by a speaker of the electronic device 112A. In some situations, the user interface 1010C may further display a message 1018 indicating a state of the user application on the focus region 1014. For example, the message 1018 is “I am listening . . . ,” indicating the microphone of the electronic device 112A is collecting the audio signal. In some embodiments, the user interface 1010D does not display any message with the voice assistance affordance item 1010 on the focus region 1014. A visual pattern of the voice assistance affordance item 1010 displayed on the user interface 1010D is distinct from a respective visual pattern of the affordance item 1010 on any of the other user interfaces 1010A-1010C, indicating that the audio signal is being converted to digital data. A subset of the audio signal is converted to the one or more query messages 802.

In some embodiments, the user interface 1000 includes a text box 1020 where the one or more query messages 802 may be typed (e.g., at once or successively). More details on using the query messages 802 entered via the microphone or the text box 1020 to update information lists 222 are discussed above with reference to FIGS. 8 and 9. For example, a user 122A may use utterances (e.g., “Add Apples to Cart,” “Add Flavored Water into Weekly Shopping List,” etc.) to enhance user experience on a cloud-based information platform. The utterances are analyzed to extract a user request 804 including at least basic item information 806 of items 808 that interest the user 122A. A target information list 222T is identified based on the user request. Updated item information 822 (e.g., specific item information) may be generated to identify items in the item database 228. The basic item information 806 or updated item information 822 may be applied to update the target information list 222T.

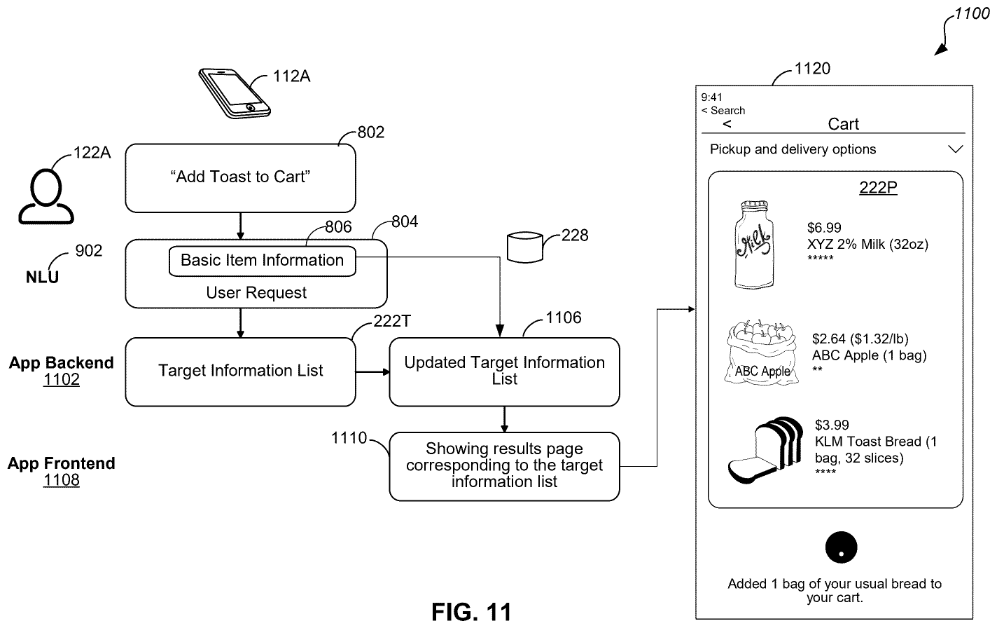

FIG. 11 is a flow diagram of a method 1100 of rendering a user interface 1120 including a predefined information list 222P that is identified as a target information list 222T in response to an example query message 802, in accordance with some embodiments. The query message 802 is collected by an electronic device 112A associated with a first user 122A. The query message 802 is “Add Toast to Cart.” The natural language unit 902 of the information processing module 224 (FIG. 9) analyzes the query message 802, and determines basic item information 806 associated with one or more items 808. The basic item information 806 includes generic item information of “toast,” which defines an item type for the one or more items 808. A user request 804 may be determined based on the query message 802 to include the basic item information 806. In an application backend 1102, the target information list 222T is identified based on the user request 804 and updated (operation 1106) based on the basic item information 806. In an application frontend 1108, a result page is presented on the user interface 1120 and includes (operation 1110) the target information list 222T, e.g., a predefined information list 222P of “a virtual shopping cart” added with specific item information of “KLM Toast Bread” identified in an item database 228.

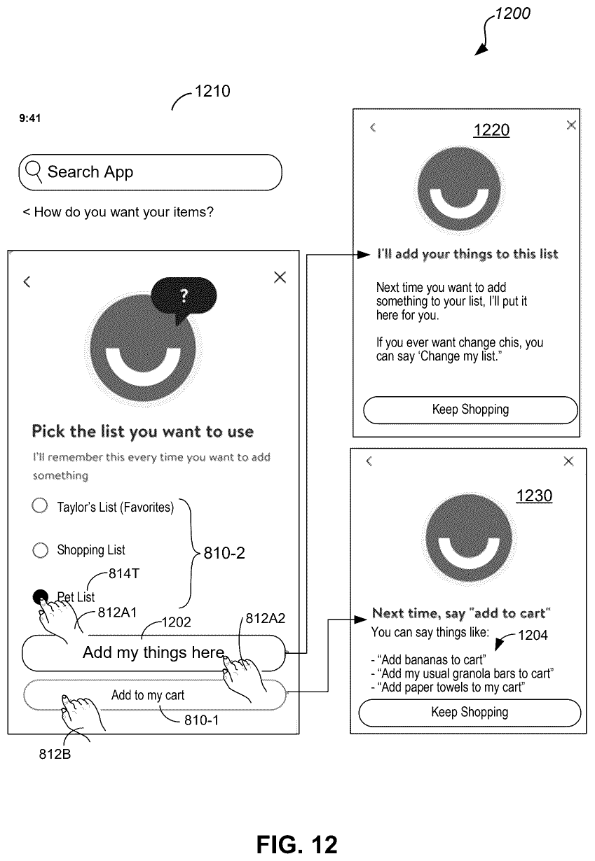

FIG. 12 is a diagram illustrating example user interfaces 1200 prompting selection of a target information list 222T, in accordance with some embodiments. A user application 218 is executed to enable display of a user interface 1210 associated with the user application 218. One or more query messages 802 are provided by a first user 122A via the user application 218, and processed to generate a user request 804 for modifying a target information list 122T with basic item information 806 associated with one or more items 810. In response to the user request 804, one or more candidate information items 810 representing a subset of a plurality of information lists 222 available to the first user 122A are generated and presented on the user interface 1210 of the user application 218. Referring to FIG. 12, in some embodiments, the one or more query messages 802 broadly recite “add an item” or “add an item to my list” without clarifying “list” corresponds to “cart” or “list,” and the one or more candidate information items 810 represent a predefined information list 222P and custom information lists 222C. Specifically, a first information item 810-1 represents a predefined information list 222P (e.g., “my cart”), and three second information items 810-2 correspond to three custom information lists 222C (e.g., “Taylor's List,” “Shopping List,” and “Pet List”). A user account 220 associated the first user 122A may have more than three (e.g., 100) custom information lists 222C, and these three custom information lists are selected based on the one or more query messages 802, e.g., by a core processing module 906 (FIG. 9).

In some situation, a user input 812 selects one of the custom information lists 222C. The one or more custom information lists 222C may be customized for each user account 220 and configured to include either specific item information of one or more items in the item database 228 (see FIG. 2) or generic item information that correspond to an item type of items. A user action 812A1 is applied on one of the second information items 810-2 to identify a target information item 814 (e.g., “Pet List”) representing the target information list 222T, and followed with a user click 812A2 on an affordance 1202 (e.g., “Add my things here”) to select the target information item 814. A user interface 1220 may be presented to confirm that the target information list 222T has been selected. For example, the user interface 1220 displays a message, “I'll add your things to this list.” The target information list 222T is further updated based on the basic item information 806.

Alternatively, in some embodiments, a user input 812 selects a predefined information list 222P (e.g., “my cart”). The predefined information list 222P may be named with a first semantic term (e.g., “cart”) for all of the plurality of user accounts 220 and configured to include only specific item information of one or more items that may be found in an item database 228. The one or more items on the predefined information list 222P may be ordered upon a user confirmation, and the user application 218 may enable online or offline operations to facilitate delivery of the one or more items on the predefined information list 222P. A user action 812B is applied on the first information item 810-1 to identify it as the target information item 814, and the corresponding predefined information list 222P is identified as the target information list 222T. A user interface may be presented to confirm that the target information list 222T has been selected. In some embodiments, a user interface 1230 is displayed to guide the first user 122A to identify the predefined information list 222P promptly during future interactions. For example, the user interface 1230 displays messages 1204 including “Next time, say ‘add to cart’” or “You can say things like, ‘Add bananas to cart,’ ‘Add my usual granola bars to cart,’ or ‘Add paper towels to my cart’.” These messages help the first user 122A use specific query messages 802 for directly adding items to “cart.”

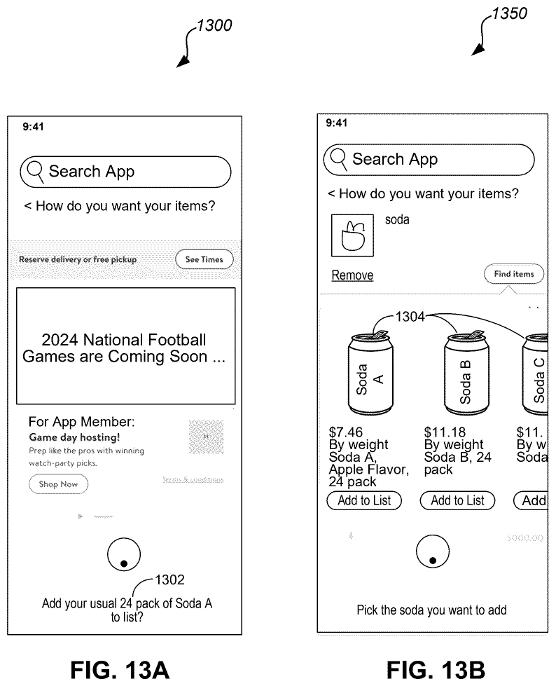

FIGS. 13A and 13B are diagrams illustrating two example user interfaces 1300 and 1350 presenting item information added into a target information list 222T, in accordance with some embodiments. Basic item information 806 generated from the one or more query messages 802 is associated with a target item 808A for which specific item information is stored in an item database 228 (FIG. 2). The basic item information 806 may be updated based on the specific item information of the target item 808A to generate updated item information 822. The basic item information 806 or updated item information 822 may be applied to update the target information list 222T. In some embodiments, the target item 808A may be identified based on historic transaction data 824 of a first user 122A. For example, the target item 808A is identified as “24 pack of Soda A” listed in the item database 228. Stated another way, “24 pack of Soda A” is a top match in the historic transaction data 824 associated with the first user 122A. Referring to FIG. 13A, the user interface 1300 displays a message 1302, “Add your usual 24 pack of Soda A to list?,” requesting a user confirmation.

Alternatively, in some embodiments, the historic transaction data 824 of the first user 122A does not match the basic item information 806 (e.g., because the first user 122A never purchased the target item 808A). In some embodiments, the first user 122A does not provide the user confirmation to the top match of the historic transaction data, e.g., rejects the recommendation made based on the historic transaction data 824. A search request may be generated based on the one or more query messages 802 or the basic item information 806 generated from the one or more query messages 802. For example, the basic item information 806 identified from the one or more query messages 802 includes “soda.” In response to the search request, an item search engine 826 (FIG. 8) searches in the item database 228 to identify one or more items 1304 for which specific item information is stored in the item database 228. The first user 122A may select the target item 808A (i.e., a target item) by clicking on one of “Add to List” affordances. The basic item information 806 may be updated based on the specific item information of the selected first information item 810-1. The specific item information of the selected first information item 810-1 is then added to the target information list 222T.

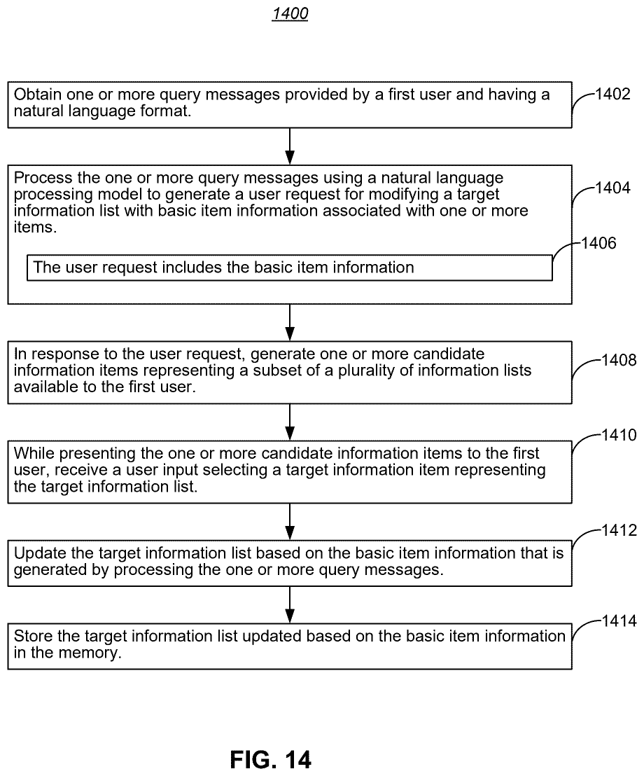

FIG. 14 is a flowchart illustrating a method 1400 for managing information, in accordance with some embodiments. The method 1400 is implemented by a system (e.g., including a computing device 102 and/or a cloud-based engine 121 in FIG. 1). Method 1400 may be governed by instructions that are stored in a non-transitory computer readable storage medium and that are executed by one or more processors of a system (e.g., a computing device 102). Each of the operations shown in FIG. 14 may correspond to instructions stored in a computer memory or non-transitory computer readable storage medium (e.g., memory 202 in FIG. 2). The computer readable storage medium may include a magnetic or optical disk storage device, solid state storage devices such as Flash memory, or other non-volatile memory device or devices. The instructions stored on the computer readable storage medium may include one or more of: source code, assembly language code, object code, or other instruction format that is interpreted by one or more processors. Some operations in method 1400 may be combined and/or the order of some operations may be changed.

A system (e.g., a computing device 102, a cloud-based engine 121, etc. (see FIG. 1)) obtains (operation 1402) one or more query messages 802 provided by a first user 122A and having a natural language format. The system processes (operation 1404) the one or more query messages 802 using a natural language processing model to generate a user request 804 for modifying a target information list 222T with basic item information 806 associated with one or more items. The user request 804 includes (operation 1406) the basic item information 806. In response to the user request 804, the system generates (operation 1408) one or more candidate information items 810 representing a subset of a plurality of information lists 222 available to the first user 122A. While presenting the one or more candidate information items 810 to the first user 122A, the system receives (operation 1410) a user input selecting a target information item 814 representing the target information list 222T. The system updates (operation 1412) the target information list 222T based on the basic item information 806 that is generated by processing the one or more query messages 802 and stores (operation 1414) the target information list 222T updated based on the basic item information 806 in the memory.

In some embodiments, the system executes a user application 218 including a plurality of user accounts 220, and generates instructions to display the one or more candidate information items 810 on a user interface of the user application 218 executed on an electronic device 112A associated with a first user 122A account associated with the first user 122A. Further, in some embodiments, the system generates instructions to display the target information list 222T on the user interface of the user application 218 executed on the electronic device 112A.

In some embodiments, the one or more query messages 802 include a first semantic term 816 (e.g., “cart”) and the one or more candidate information items 810 includes a first information item 810-1 representing a predefined information list 222P of the first user 122A. Further, in some embodiments, the predefined information list 222P has an item information condition requiring that the basic item information 806 be added to the predefined information list 222P in accordance with a determination that the basic item information 806 matches information of individual items in an item database 228 (FIG. 2).

In some embodiments, the system executes a user application 218 including a plurality of user accounts 220. For each user account 220 associated with a respective user 122, the plurality of information lists 222 includes a predefined information list 222P and one or more custom information lists 222C. The predefined information list 222P is named with a first semantic term 816 (e.g., “cart”) for all of the plurality of user accounts 220 and configured to include only specific item information of one or more items in an item database 228. The one or more custom information lists 222C are customized for each user account 220 and configured to include both generic item information that correspond to an item type of items in the item database 228 and the specific item information. Further, in some embodiments, the one or more query messages 802 include a second semantic term 818 (e.g., “List”), and the one or more candidate information items 810 include a first information item identifying the predefined information list 222P and a second information item identifying at least one of the one or more custom information lists 222C. Additionally, in some embodiments, the natural language processing model includes a classifier configured to, in response to the one or more query messages 802 including the second semantic term 818, generate the user request 804 for both the predefined information list 222P and the one or more custom information lists 222C. Generating one or more candidate information items 810 further includes selecting the at least one of the one or more custom information lists 222C based on the one or more query messages 802.

In some embodiments, the system updates the target information list 222T by, in accordance with a determination that the target information list 222T corresponds to the at least one of the one or more custom information lists 222C, adding the basic item information 806 identified with the user request 804 to the target information list 222T, independently of whether the basic item information 806 matches information of individual items in an item database 228.

In some embodiments, the one or more query messages 802 include identification information of a first custom information list 222C, and the user request 804 at identifies the first custom information list 222C as the target information list 222T. The one or more candidate information items 810 include at least the target information item 814 representing the target information list 222T. Further, in some embodiments, the natural language processing model includes a classifier configured to, in response to the one or more query messages 802, extract the user request 804 identifying the first custom information list 222C as the target information list 222T. The system generates one or more candidate information items 810 by including the target information item 814 representing the target information list 222T in the one or more candidate information items 810.

In some embodiments, the system associates the basic item information 806 generated from the one or more query messages 802 with a target item 808A for which specific item information is stored in an item database 228, and updates the basic item information 806 generated from the one or more query messages 802 based on the specific item information of the target item. The updated item information is added into the target information list 222T. Further, in some embodiments, the target item is identified based on historic transaction data of the first user 122A. In some embodiments, in accordance with a determination that historic transaction data of the first user 122A does not match the basic item information 806, the system generates a search request for an item search engine based on the one or more query messages 802 or the basic item information 806 generated from the one or more query messages 802 to identify the target item for which the specific item information is stored in the item database 228. In some embodiments, the basic item information 806 generated from the one or more query messages 802 is associated with the target item, in accordance with a determination that the target information list 222T corresponds to a predefined information list 222P. In some embodiments, the target information list 222T is one of a plurality of custom information lists 222C.

In some embodiments, wherein the one or more query messages 802 includes at least one of a plurality of predefined key words, and each predefined key word corresponds to a respective set of one or more candidate information items 810. Further, in some embodiments, based on the basic item information 806 generated from the one or more query messages 802, the system presents one of more candidate information items 810 associated with candidate items for which specific item information is stored in an item database 228. The system receives a user selection of a target item and modifies the basic item information 806 generated from the one or more query messages 802 based on item information of the target item.

In some embodiments, the system executes a user application 218 including enabling display of a user interface 1000 associated with the user application 218 and enables display of a voice assistant affordance item 1010 (FIG. 10) on the user interface 1000, independently of content concurrently displayed on the user interface 1000. In response to detection of a user action 1012 on the voice assistance affordance item 1010, the system obtains an audio signal collected via a microphone. A subset of the audio signal is converted to the one or more query messages 802.

In some embodiments, the system executes a user application 218 including enabling display of a user interface 1000 (FIG. 10) associated with the user application 218. The one or more query messages 802 are entered by the first user 122A on the user interface 1000.

It should be understood that the particular order in which the operations in FIG. 14 have been described are merely exemplary and are not intended to indicate that the described order is the only order in which the operations could be performed. One of ordinary skill in the art would recognize various ways to cache and distribute specific data as described herein. Additionally, it should be noted that details of other processes described herein with respect to FIGS. 8-14 are also applicable in an analogous manner to method 1400 described above with respect to FIG. 14. For brevity, these details are not repeated here.

Each functional component described herein may be implemented in computer hardware, in program code, and/or in one or more computing systems executing such program code as is known in the art. As discussed above with respect to FIG. 2, such a computing system may include one or more processing units which execute processor-executable program code stored in a memory system. Similarly, each of the disclosed methods and other processes described herein may be executed using any suitable combination of hardware and software. Software program code embodying these processes may be stored by any non-transitory tangible medium, as discussed above with respect to FIG. 2.

The foregoing is provided for purposes of illustrating, explaining, and describing embodiments of these disclosures. Modifications and adaptations to these embodiments will be apparent to those skilled in the art and may be made without departing from the scope or spirit of these disclosures. Although the subject matter has been described in terms of exemplary embodiments, it is not limited thereto. Rather, the appended claims should be construed broadly, to include other variants and embodiments, which may be made by those skilled in the art.

What is claimed is:

1. A system, comprising:
memory having instructions stored thereon; and
at least one processor operatively coupled to the memory and configured to read the instructions to:
obtain one or more query messages provided by a first user and having a natural language format;
process the one or more query messages using a natural language processing model to generate a user request for modifying a target information list with basic item information associated with one or more items, the user request including the basic item information;
in response to the user request, generate one or more candidate information items representing a subset of a plurality of information lists available to the first user;
while presenting the one or more candidate information items to the first user, receive a user input selecting a target information item representing the target information list;
update the target information list based on the basic item information that is generated by processing the one or more query messages; and
store the target information list updated based on the basic item information in the memory.

2. The system of claim 1, further comprising instructions to:
execute a user application including a plurality of user accounts; and
generate instructions to display the one or more candidate information items on a user interface of the user application executed on an electronic device associated with a first user account associated with the first user.

3. The system of claim 2, further comprising instructions to generate instructions to display the target information list on the user interface of the user application executed on the electronic device.

4. The system of claim 1, wherein the one or more query messages include a first semantic term and the one or more candidate information items includes a first information item representing a predefined information list of the first user.

5. The system of claim 4, wherein the predefined information list has an item information condition requiring that the basic item information be added to the predefined information list in accordance with a determination that the basic item information matches information of individual items in an item database.

6. The system of claim 1, further comprising instructions to execute a user application including a plurality of user accounts, wherein:
for each user account associated with a respective user, the plurality of information lists includes a predefined information list and one or more custom information lists;
the predefined information list is named with a first semantic term for all of the plurality of user accounts and configured to include only specific item information of one or more items in an item database; and
the one or more custom information lists are customized for each user account and configured to include both generic item information that correspond to an item type of items in the item database and the specific item information.

7. The system of claim 6, wherein the one or more query messages include a second semantic term, and the one or more candidate information items include a first information item identifying the predefined information list and a second information item identifying at least one of the one or more custom information lists.

8. The system of claim 7, wherein the natural language processing model includes a classifier configured to in response to the one or more query messages including the second semantic term, generate the user request for both the predefined information list and the one or more custom information lists, wherein generating one or more candidate information items further comprises selecting the at least one of the one or more custom information lists based on the one or more query messages.

9. The system of claim 6, wherein the instructions to update the target information list further comprises instructions to:
in accordance with a determination that the target information list corresponds to the at least one of the one or more custom information lists, add the basic item information identified with the user request to the target information list, independently of whether the basic item information matches information of individual items of specific items in an item database.

10. The system of claim 1, wherein the one or more query messages include identification information of a first custom information list, and the user request at identifies the first custom information list as the target information list, and wherein the one or more candidate information items include at least the target information item representing the target information list.

11. The system of claim 10, wherein the natural language processing model includes a classifier configured to, in response to the one or more query messages, extract the user request identifying the first custom information list as the target information list, and wherein generating one or more candidate information items further comprises including the target information item representing the target information list in the one or more candidate information items.

12. A method, comprising:
at a system including memory having instructions stored thereon and at least one processor operatively coupled to the memory and configured to read the instructions:
obtaining one or more query messages provided by a first user and having a natural language format;
processing the one or more query messages using a natural language processing model to generate a user request for modifying a target information list with basic item information associated with one or more items, the user request including the basic item information;
in response to the user request, generating one or more candidate information items representing a subset of a plurality of information lists available to the first user;
while presenting the one or more candidate information items to the first user, receiving a user input selecting a target information item representing the target information list;
updating the target information list based on the basic item information that is generated by processing the one or more query messages; and
storing the target information list updated based on the basic item information in the memory.

13. The method of claim 12, wherein the instructions to update the target information list based on the basic item information further comprise instructions to:
associate the basic item information generated from the one or more query messages with a target item for which specific item information is stored in an item database; and
update the basic item information generated from the one or more query messages based on the specific item information of the target item, wherein the updated item information is added into the target information list.

14. The method of claim 13, wherein updating the target information list based on the basic item information further comprises identifying the target item based on historic transaction data of the first user.

15. The method of claim 13, wherein updating the target information list based on the basic item information further comprises:
in accordance with a determination that historic transaction data of the first user does not match the basic item information, generating a search request for an item search engine based on the one or more query messages or the basic item information generated from the one or more query messages to identify the target item for which the specific item information is stored in the item database.

16. The method of any of claim 13, wherein when the target information list corresponds to a predefined information list, the basic item information that is generated from the one or more query messages is associated with the target item.

17. A non-transitory computer-readable storage medium, having instructions stored thereon, which when executed by one or more processors cause the processors to:
obtain one or more query messages provided by a first user and having a natural language format;
process the one or more query messages using a natural language processing model to generate a user request for modifying a target information list with basic item information associated with one or more items, the user request including the basic item information;
in response to the user request, generate one or more candidate information items representing a subset of a plurality of information lists available to the first user;
while presenting the one or more candidate information items to the first user, receive a user input selecting a target information item representing the target information list;
update the target information list based on the basic item information that is generated by processing the one or more query messages; and
store the target information list updated based on the basic item information in memory.

18. The non-transitory computer-readable storage medium of claim 17, wherein the one or more query messages includes at least one of a plurality of predefined key words, and each predefined key word corresponds to a respective set of one or more candidate information items.

19. The non-transitory computer-readable storage medium of claim 18, wherein updating the target information list based on the basic item information further comprises:
based on the basic item information generated from the one or more query messages, presenting one of more candidate information items associated with candidate items for which specific item information is stored in an item database; and
receiving a user selection of a target item; and
modifying the basic item information generated from the one or more query messages based on item information of the target item.

20. The non-transitory computer-readable storage medium of claim 17, further comprising instructions to:
execute a user application including enabling display of a user interface associated with the user application;
enable display of a voice assistant affordance item on the user interface, independently of content concurrently displayed on the user interface; and
in response to detection of a user action on the voice assistance affordance item, obtaining an audio signal collected via a microphone, wherein a subset of the audio signal is converted to the one or more query messages.
